(19) United States
(12) Patent Application Publication
(10) Pub. No.: US 2009/0019498 A1
(43) Pub. Date: Jan. 15, 2009

(54) METHOD AND SYSTEM FOR GENERATING SPECIFIC SEGMENTS OF A PROGRAM

(75) Inventors: Yongqin Zeng, Shanghai (CN); Xin Chen, Shanghai (CN); Ningjiang Chen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,702

(22) PCT Filed: Dec. 14, 2004
(86) PCT No.: PCT/IB2004/052798

§ 371 Date: Jun. 22, 2006

(30) Foreign Application Priority Data
Dec. 29, 2003 (CN) 200310124522.4

(51) Int. Cl. H04N 7/087

(52) U.S. Cl. 725/87

(57) ABSTRACT

The present invention provides a method for creating a specific segment during broadcasting program. Firstly, sending a program to an user terminal; then receiving a request of an user from the user terminal, which requests to create a specific segment, wherein the specific segment is part of the broadcasting program; finally creating the specific segment according to the request. Furthermore, the invention can also send the created specific segment to the user terminal. The invention solves the problem that the choice standard for the specific segment specified by the broadcasting program supplier/the program producer does not meet the real requirement of the users, thereby the users can obtain their required specific segments during watching program to satisfy their individual needs.

### BACKGROUND OF THE INVENTION

The present invention relates to a method and an apparatus for creating a specific segment of a program, and more particularly relates to a method and an apparatus for creating specific segment of a program during broadcasting the program.

During broadcasting program (including analogue program and digital program), some specific segments that is interesting to the audience, such as the shooting scene in a football game, the key points/difficulty parts in a class teaching, are expected to be repeated for watching during broadcasting program or after broadcasting program. To satisfy this demand of the audience, the program broadcaster generally produces a wonderful segment for the audience in a film editing mode in a specific time, for example, after broadcasting program, according to the selection standard specified by the program broadcaster.

FIG. 1 is a schematic drawing of a conventional system of using program broadcasting to perform multimedia teaching. Any user (user 1, user 2, . . . , user n) may obtain a teaching program to broadcast from a server connected to the Internet 150, such as a network sever 110 or a network sever 120 with the function of program producing, by means of a terminal equipment, such as a computer 130 or a TV receiving equipment 140, which is connected to the Internet 150.

The TV receiving equipment 140 comprises a TV set, a set-top-box and a remote control. During broadcasting program, the user inputs his feedback information from the terminal equipment and the information is sent to the server via the Internet.

The network sever 120 with the function of program producing may be connected with a photograph and record apparatus. The program producer records the teaching program in real time at the teaching spot and afterwards broadcasts the program in real time.

Of course, the broadcasting of above program may also be performed in the air/by the cable. Wherein, the user's feedback information may still be transmitted back to the broadcast terminal via the Internet, when the broadcasting is performed in the air, such as by means of the satellite or the terrestrial broadcast transmitting tower.

In the prior art multimedia teaching systems, the broadcasting program supplier/the program producer may also choose some key points/difficult parts in a broadcasted class teaching according to the selection standard specified by themselves and send them to users in the form of a specific segment, at a specific time, for example, during broadcasting program or after broadcasting program.

The prior art method for creating a specific segment determines whether to create a specific segment or not only according to the selection standard specified by the program broadcasting supplier/program producer, however the specific segment determined according to said standard is not necessarily what the user is interested in. Therefore, the method can't satisfy the user's individual needs, such as requirement of browsing his interested specific segment again, during watching program in real time.

Therefore, a new method and apparatus for creating a specific segment of program is requested, which may satisfy the user's individual needs by obtaining his desired specific segment during watching program.

### SUMMARY OF THE INVENTION

One object of the present invention is to avoid the drawback of the prior art apparatus for creating a specific segment and to provide a method and apparatus for creating a specific segment according to requests of users.

The present invention provides a method for creating a specific segment during broadcasting program. Firstly, receiving a request of an user from an user terminal, which requests to create a specific segment, wherein the specific segment is part of the program; then creating the specific segment according to the request. Furthermore, the method can also send the created specific segment to the user terminal.

When a number of requests for creating a specific segment are received from the user terminals, the method can also make a statistical analysis of these requests. The statistical analysis may be made according to the classification of the users.

The present invention also provides an apparatus for creating a specific segment during broadcasting program. The apparatus comprises means for receiving a request of an user from an user terminal, which requests to create a specific segment, wherein the specific segment is part of the program; and means for creating the specific segment according to the request.

The apparatus for creating a specific segment during broadcasting program further comprises sending means for sending the program to the user terminal. The sending means is also arranged for send the specific segment to the user terminal.

The apparatus for creating a specific segment during broadcasting program further comprises means for making the statistical analysis of the request.

The present invention can solve the problem that the selection standard specified by the broadcasting program supplier/program producer does not meet the real requirements of the users, thereby the users may obtain their requested specific segments during watching program to satisfy their individual needs.

Other objects and advantages of the present invention should be apparent and the invention should be more readily appreciated from the following description and claims in conjunction with the accompanying drawings.

### BRIEF DESCRIPTION OF DRAWINGS

The present invention will be explained in detail by way of examples in conjunction with the accompanying drawings, in which:

FIG. 1 is a schematic of a conventional system of using program broadcasting to perform multimedia teaching;

FIG. 2 is a system block diagram of an apparatus for creating a specific segment during broadcasting program in accordance with one embodiment of the present invention;

FIG. 3 is a flow diagram for creating a specific segment during broadcasting program in accordance with one embodiment of the present invention;

FIG. 4 is a schematic drawing of the result of making a statistical analysis of the received user's requests in accordance with one embodiment of the present invention;

FIG. 5 is a flow diagram of a user obtaining his desired specific segment during broadcasting program in accordance with one embodiment of the present invention.

In the accompanying drawings, same reference numerals designate similar or same features and functions throughout.

### DETAILED DESCRIPTION OF THE INVENTION

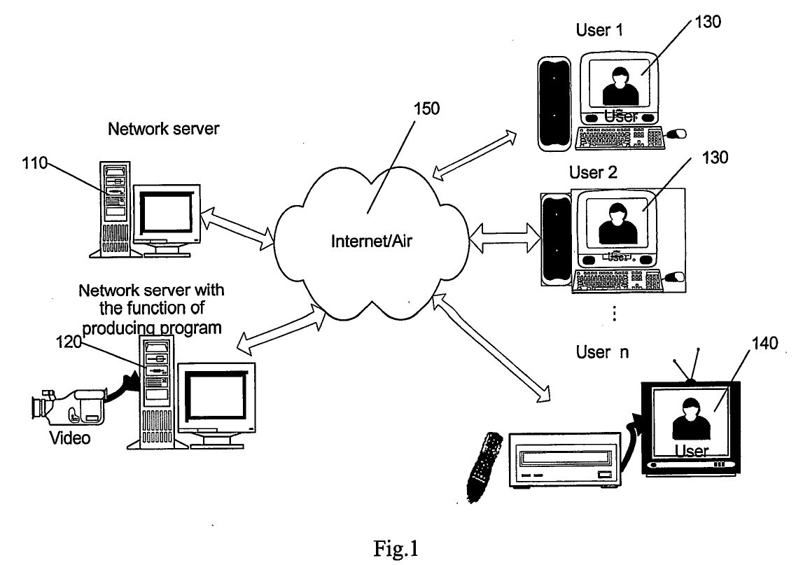

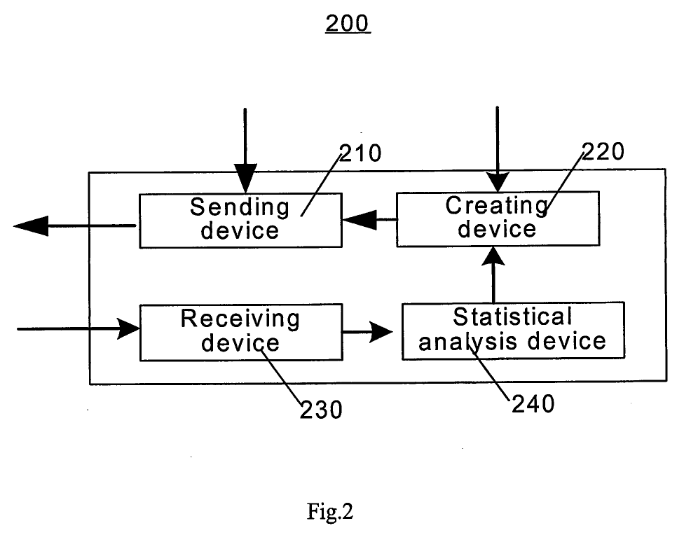

FIG. 2 is a system block diagram of an apparatus for creating a specific segment during broadcasting program in accordance with one embodiment of the present invention. The apparatus 200 may be a part of the network server 100 shown in FIG. 1. The apparatus 200 comprises a sending device 210, a receiving device 230 and a creating device 220. The device 200 may further comprise a statistical analysis device 240.

The sending device 210 is used to send a program to the user terminal, or to send the specific segment created by the creating device 220 to the user terminal. The program may be a multimedia teaching program from a storage device of the network sever 110 (not shown in FIG. 2) or from a pickup and record device (not shown in FIG. 2).

The receiving device 230 is used to receive a user's request from a user terminal, which requests to create a specific segment, the content of which is a part of the content of the broadcasting program.

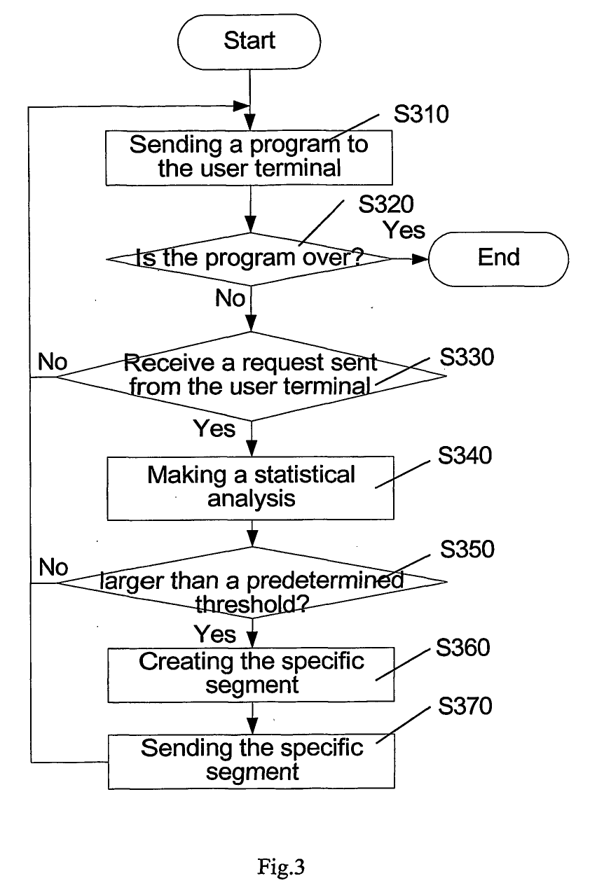

The creating device 220 is used to create a requested specific segment according to the user's request received by the receiving device 230. The creating method of the creating device is shown in the following FIG. 3.

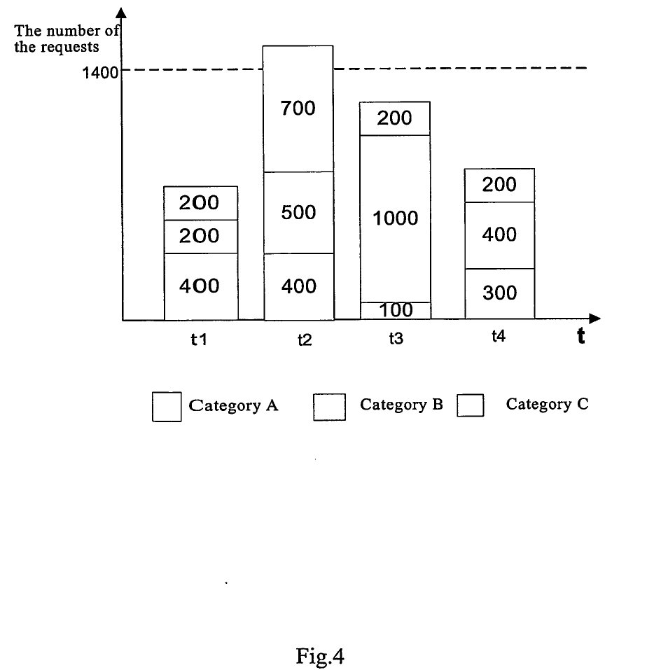

The statistical analysis device 240 is used to make a statistical analysis of the received user's requests. The analysis may be made according to the classification of the users. The operating flow of the statistical analysis device is shown in the following FIG. 3 and FIG. 4.

FIG. 3 is a flow diagram for creating a specific segment during broadcasting program in accordance with one embodiment of the present invention. The flow is usually performed at the broadcasting terminal of the program, such as the server terminal. First, sending a program to the user terminal (step S310), which is a continuous step and does not end until finishing broadcasting the program. The program may be a multimedia teaching program. The sending of the program may be multicasting via the Internet, or broadcasting in the air/cable network, such as satellite or broadcast transmitting tower.

Next, it is judged whether the broadcasting of the program is over or not (step S320). If not, i.e., during broadcasting of the program, continue to judge whether a request from a user terminal has been received, which requests to send a specific segment to the user terminal (step S330). The sending of the specific segment and the sending of the broadcasting program may be performed simultaneously. If no such request is received, then return to step S310 to continue to send the specific program to the user terminal. The format of the request is shown in table 1.

TABLE 1
content format of the user's request

| | | program identification | degree of |
|---|---|---|---|
| request type | request time | number | demand |
| specific | 00:10:03 | 0x100 | 3 |
| segment | | | |

Wherein, the value of “request type” is “specific segment”, indicating that the request is the one which requests to send a specific segment; the value of “request time” is “00:10:03”, indicating that the request is sent at 00:10:03 after starting broadcasting the program, which requests a specific segment, the broadcasting time of which covers the time; of course, there are other methods to define the location of said specific segment, such as a starting location and an ending location; the value of “program identification number” is “0x100”, indicating that the identification number of the broadcasting program is 0x100; the value of “degree of demand” is “3”, indicating that the degree of the user's demand for the specific segment is middling degree, and the degree of the demand may be classified into 5 degrees from high to low: 1, 2, 3, 4 and 5.

The request in step S330 may be a number of requests for one same program content from a number of users. The common ground of these requests is that all requesting to send the same specific segment, the content of which is a part of the content of the broadcasting program, including said same content. For example, when a number of student users feel confused when the teaching program comes to the content of the theory of Viète, they may propose one same request during a specific period, which requests to send the specific segment associated with the theory of Viète again.

If requests are received from user terminals in step S330, which request to send specific segments to user terminals, a further statistical analysis is made to these requests (step S340). During the process of the statistical analysis, the users may be classified into different categories, such as category A, category B, category C, etc., wherein category A designates the part of users whose academic performance are usually good; category B designates the part of users whose academic performance are usually mediocre; and category C designates the part of users whose academic performance are usually poor, so as to analyze different demands of different users more exactly.

According to the statistical analysis, the number of requests sent from category A users, category B users, category C users and all users may be obtained at a certain time, and the result illustration of the statistical analysis is shown in FIG. 4.

Then, it is further judged whether the number of said requests is larger than a predetermined threshold (step S350) or not. If not, return to step S310 to continue to send the specific program to the user terminal. Herein, for different categories, different thresholds may be predetermined. For example, for users of category A, the threshold may be 500, and for users of category B, the threshold may be 800.

If the result of the judgment is positive in step S350, then the desired specific segment is created according to the user's request (step S360). The creating process may be receiving an input information of the program producer, which comprises the content information of the specific segment. The creating process may also be finding and extracting the specific segment from the program, using the prior art image/video analysis technique, such as scene detection or object tracking, etc.

During the creating process, some additional specific information associated with the specific segment may be created, such as title, “explanation of the theory of Viète”, length of the specific segment, “3 minutes”, and the category of the specific segment, “category A”, etc.

Finally, sending the created specific segment to the user terminal (step S370), and return to step S310 to continue to send the specific program to the user terminal. The sending of the specific segment and the sending of the broadcasting program may be performed simultaneously. Of course, the above additional specific information and the specific segment may be sent to the user together.

The sending may also send different specific segments aiming at different categories of users, or even if a user belonging to some category does not request a specific segment, the specific segment still may be sent to the user as reference since the number of requests from other users of the same category has exceeded the corresponding threshold.

During the sending, the additional specific information associated with the specific segment may be also sent to the user terminal first, then it is determined whether to send the specific segment to the user according to the feedback of the user with respect to the additional specific information.

During the whole creating process, if the number of users is not large or the number of requests is not large, a requested specific segment may be directly created according to a specific user's request, without statistical analysis, and be sent to the specific user, particularly when the degree of the demand is very high.

FIG. 4 is a schematic drawing of making statistical analysis of the received users' requests in accordance with one embodiment of the present invention. In FIG. 4, axis X designates the time of broadcasting the program, axis Y designates the number of requests from the users received at some time during broadcasting the program, and the requests request to send a specific segment to the user terminal. All of the users in FIG. 4 are classified into three categories: category A, category B, and category C.

If, in step 350 of FIG. 3, the predetermined threshold is specified as follows: the threshold for all users is 1400; the threshold for users of category A is 500; the threshold for users of category B is 800; the threshold for users of category C is 300. So it can be seen that a specific segment is requested to be created for all users at time t2; another specific segment is requested to be created for users of category B at time t3.

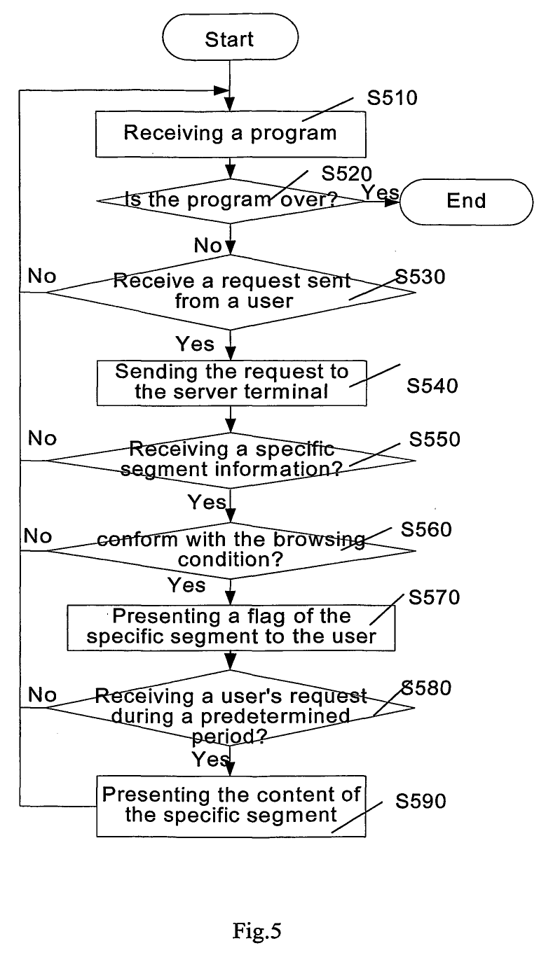

FIG. 5 is a flow diagram for a user to obtain his requested specific segment during broadcasting program in accordance with one embodiment of the present invention. The flow is usually performed at the receiving terminal of the program. First, a specific program is received (step S510), which may be a multimedia teaching program. The sending of the program may be multicasting via the Internet, or be broadcasting in the air/cable network, such as satellite or broadcast transmitting tower.

Next, it is judged whether the program broadcasting is over or not (step S520). If not, i.e., during broadcasting of the program, continue to judge whether a request from the user has been received or not, which requests the sending terminal of the program to send a specific segment to the user terminal (step S530). If no such request is received, then return to step S510 to continue to receive the specific program.

If a request is received from the user in step S530, which requests the sending terminal of the program to send a specific segment to the user terminal, then the request is sent to the program broadcast terminal (step S540), such as the server terminal. If the program is broadcasted in the air, then the request is sent to the program broadcast terminal via the Internet.

Next, it is judged whether a specific segment information (step S550) is received or not, which may be the specific segment itself or an additional specific information of the specific segment. The specific segment may be sent by the program producer according to his own selection standard or according to the user's request. If the result of the judgment is negative, then return to step S510 to continue to receive the specific program.

If the result of the judgment is positive in step S550, then further judge whether the specific segment accords with the browsing condition specified by the user (step S560) or not. If not, then return to step S510 to continue to receive the specific program. The browsing condition may be that the user only browses his own requested specific segment, or the user only browses the specific segment, the length of which is within 3 minutes. Of course, the user may specify various browsing conditions to filter the received specific segment according to his demand.

If the result of the judgment is positive in step S560, then a flag of the specific segment is presented to the user (step S570). The user may browse the additional specific information of the specific segment by selecting the flag and then browse the specific information according to his demand. Of course, the user may also browse the specific information directly by selecting the flag.

Finally, within a predetermined range of time, it is judged whether the request to browse the specific segment is received from the user or not (step S580). The user may send the browsing request by selecting the flag of the specific segment. The predetermined range of time may be specified by the program broadcast terminal, for example, to ensure the user not to browse the specific segment of the last difficult part when the next difficult part appears by specifying the range of time. If the result of the judgment is negative, then return to step S510 to continue to receive the specific program.

If the result of the judgment is positive, then the content of the specific segment is presented to the user (step S590). The presenting fashion may be in the form of picture in picture. If the information received in step S550 is an additional specific information of the specific segment, then the whole content of the specific segment is requested to be obtained from the program broadcast terminal prior to step S590.

Although the foregoing description of the detailed embodiment of the present invention has been presented for purposes of illustration, many replacements, modifications and variations are apparent to a person skilled in the art in light of the above teachings. Therefore, when such replacements, modifications and variations fall into the spirit and scope of the appended claims, they should be comprised in the present invention.

What is claimed is:

1. A method for creating a specific segment during broadcasting a program, comprising the steps of:
receiving a request of an user from an user terminal, which requests to create a specific segment, wherein the specific segment is part of the program; and
creating the specific segment according to the request.

2. The method according to claim 1, further comprising the step of:
sending the program to the user terminal.

3. The method according to claim 1, further comprising the step of:
sending the created specific segment to the user terminal.

4. The method according to claim 1, further comprising the steps of:
receiving a plurality of requests of different users from user terminals, which request to create the specific segment;
making a statistical analysis of the received requests.

5. The method according to claim 4, wherein the statistical analysis is made according to a classification of the users.

6. The method according to claim 1, further comprising the step of:
adding an additional information corresponding to the specific segment, wherein the additional information is used to explain the specific segment.

7. The method according to claim 6, further comprising the step of:
sending the additional information to the user terminal for the user to request to send the specific segment.

8. The method according to claim 7, wherein the additional information is valid within a predetermined duration for the user to request to sending the specific segment.

9. An apparatus for creating a specific segment during broadcasting program, comprising:
means for receiving a request of an user from an user terminal, which requests to create a specific segment, wherein the specific segment is part of the program; and
means for creating the specific segment according to the request.

10. The apparatus according to claim 8, further comprising:
sending means for sending the program to the user terminal.

11. The apparatus according to claim 10, wherein the sending means is arranged to send the created specific segment to the user terminal.

12. The apparatus according to claim 9, further comprising means for making the statistical analysis of the request.

13. The apparatus according to claim 9, wherein the creating apparatus is arranged to add an additional information corresponding to the specific segment, wherein the additional information is used to explain the specific segment.

14. The apparatus according to claim 13, wherein the sending apparatus is arranged to send the additional information to the user terminal for the user to request to send the specific segment.
